(19) United States
(12) Patent Application Publication
(10) Pub. No.: US 2011/0303808 A1
(43) Pub. Date: Dec. 15, 2011

(54) CAN HOLDER

(76) Inventor: Jeffrey A. Bileth, Caledonia, MI (US)

(21) Appl. No.: 12/815,021

(22) Filed: Jun. 14, 2010

(51) Int. Cl. H01F 7/00; F16M 13/00

(52) U.S. Cl. 248/206.5; 248/311.2

(57) ABSTRACT

A can holder connectable to like configured can holders comprises an upper face and a cavity and two side portions, with the cavity being used to selectively receive objects. One of the side portions includes an extension member and the other side portion includes a socket. The can holder is connectable to additional can holders with the extension member being selectively connectable to a socket of a second can holder and the socket of the can holder selectively receiving an extension member of a third can holder. The extension member may comprise a slide rail member and the socket may comprise a slide rail receiver, and the can holder may be connectable to additional can holders via dovetail joints at the side portions. A back portion may include one or more magnets for mounting the can holder to a generally vertical surface.

### BACKGROUND OF THE INVENTION

The present invention is directed to a can or bottle holder, and in particular to a can holder that is interconnectable with like configured can holders and may be mountable to a vertical surface.

Various items or materials stored in cans or bottles may be used in work places and residential settings. For example, operators in manufacturing settings may have beverages or containers of lubricants or sprays at or near their work stations. In addition to fluids, cans or bottles may be used to hold small parts or powders. Such items may occupy work surfaces, clutter a work area, or be positioned in inconvenient locations.

### SUMMARY OF THE INVENTION

The present invention provides a device for holding and organizing cans or bottles, including enables them to be conveniently mounted for ease of use or access.

According to an aspect of the present invention, a can holder connectable to like configured can holders comprises an upper face and a cavity, and two side portions, with the cavity defining a cavity opening on the upper face and being used to selectively receive objects. One of the side portions includes an extension member and the other side portion includes a socket. The can holder is connectable to additional can holders with the extension member being selectively connectable to a socket of a second can holder and the socket of the can holder selectively receiving an extension member of a third can holder.

In particular embodiments, the extension member comprises at least one slide rail member and the socket comprises at least one slide rail receiver, and in still further embodiments the can holder is connectable to additional can holders via dovetail joints at the side portions, with the extension member comprising a dovetail joint tail portion and the socket comprising a dovetail joint receptacle portion. The tail portion and the receptacle portion may be oriented for sliding engagement with additional can holders in a generally perpendicular direction relative to the longitudinal orientation of the cavity. A back portion of the can holder may include a mounting element, such as one or more magnets, for mounting the can holder to a generally vertical surface. A cover member may be placed over the back portion to cover such magnets. Also in particular embodiments, the can holder is generally cubical, with the side portions being disposed on opposite sides and being generally perpendicular relative to the upper face. The cavity may be substantially cylindrical.

According to another aspect of the present invention, interconnectable can holders comprise a plurality of can holders with each can holder comprising an upper face and a cavity, and two side portions. The cavity defining a cavity opening on the upper face with the cavity being used to selectively receive objects, and with one of the side portions including an extension member and the other side portion including a socket. The extension member of each can holder being selectively connectable to the socket of another can holder, and the socket of each can holder being selectively connectable to the extension member of another can holder to adjacently interconnect the can holders.

Each can holder may be generally cubical in particular embodiments of the interconnectable can holders, with the side portions being disposed on opposed sides such that the side portions are generally planar and parallel with respect to one another and are generally perpendicular relative to the upper face. The extension member may comprise at least one slide rail member, and the socket may comprise at least one slide rail receiver. The can holders may be interconnectable via dovetail joints at the side portions, and may include one or more magnets on a back portion for mounting to a generally vertical metallic surface.

According to still another aspect of the present invention, a can holder that is connectable to like configured can holders comprises an upper face and a cavity, two side portions, and a back portion, with the back portion including one or more magnets enabling the can holder to be mounted to a generally vertical metallic surface. The cavity defines a cavity opening on the upper face with cavity being used to selectively receive objects. The can holder being generally cubical, with the side portions being disposed on opposed sides such that the side portions are generally planar and parallel with respect to one another and such that the side portions are generally perpendicular relative to the upper face, and with the back portion being generally perpendicular to the side portions and the upper face. The can holder being connectable to additional can holders via dovetail joints at the side portions with one of the side portions including an extension member and the other side portion including a socket with the extension member comprising a dovetail joint tail portion and the socket comprising a dovetail joint receptacle portion with the tail portion being selectively connectable to a receptacle portion of a second can holder and the receptacle portion of the can holder selectively receiving a tail portion of a third can holder.

The can holders thus provide a convenient storage retainer for cans and bottles and may not require horizontal surfaces, where the connecting members of the side portions enable two or more can holders to be organized together in interconnected formation. Magnets on the back portions of the can holders may be used to enable the can holders to be mounted to generally vertical metallic surfaces, such as work benches or tool boxes. Accordingly, the can holders provide convenient and organized storage for cans and bottles, and even for parts and/or components that might be stored within the holders.

These and other objects, advantages, purposes and features of this invention will become apparent upon review of the following specification in conjunction with the drawings.

### BRIEF DESCRIPTION OF THE DRAWINGS

FIG. 1 is a front perspective view of a series of interconnected can holders in accordance with an aspect of the present invention shown mounted to a generally vertical surface;

FIG. 2 is a rear perspective view of the interconnected can holders of FIG. 1 shown removed from the generally vertical surface;

FIG. 3 is a front perspective view of a single can holder in accordance with an aspect of the present invention;

FIG. 4 is a lower rear perspective view of the can holder of FIG. 3;

FIG. 5 is a front elevation view of the can holder of FIG. 3;

FIG. 6 is a right side elevation view of the can holder of FIG. 3;

FIG. 7 is a left side elevation view of the can holder of FIG. 3;

FIG. 8 is a top plan view of the can holder of FIG. 3;

FIG. 9 is a bottom plan view of the can holder of FIG. 3;

FIG. 10 is a rear elevation view of the can holder of FIG. 3; and

FIG. 11 is a rear elevation view of the can holder of FIG. 3 shown with a cover member over the back portion of the can holder.

### DESCRIPTION OF THE PREFERRED EMBODIMENTS

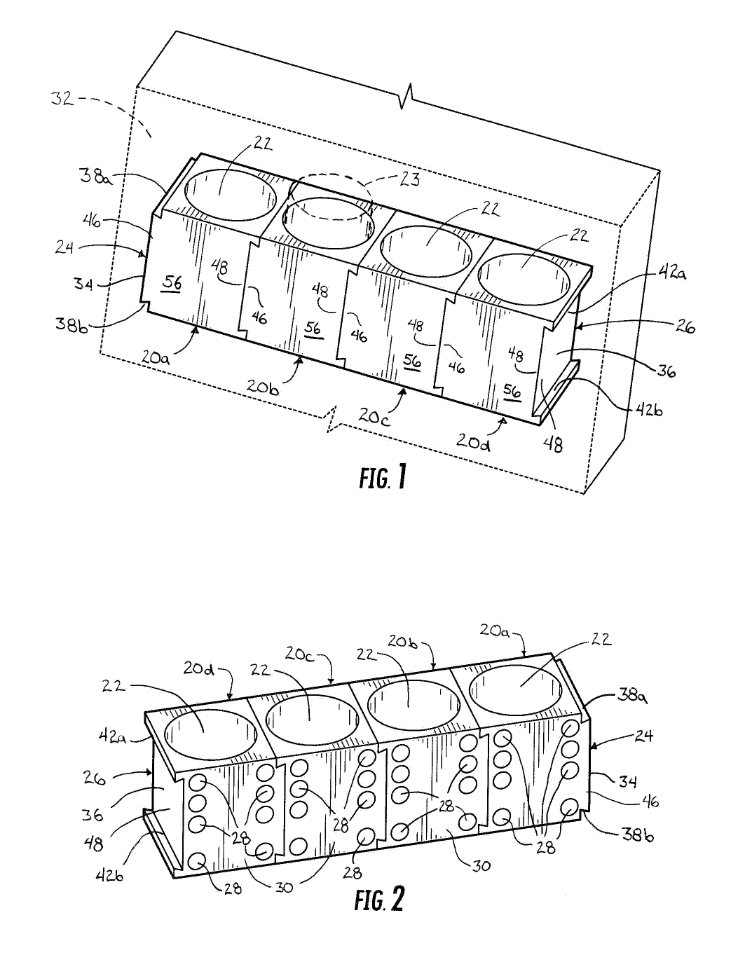

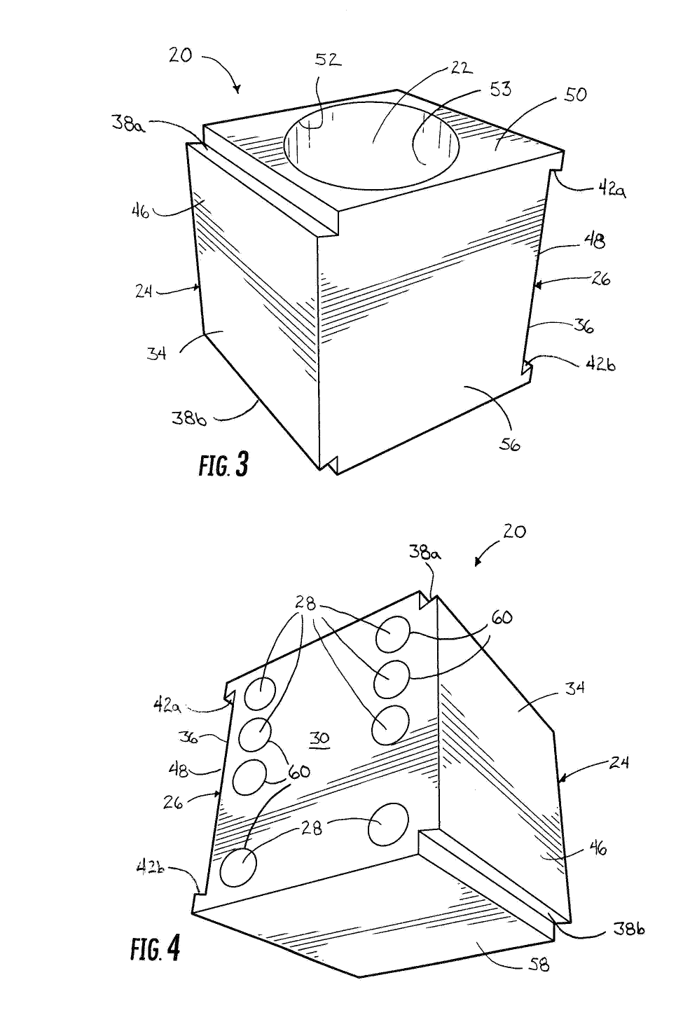

The present invention will now be described with reference to the accompanying figures, wherein the numbered elements in the following written description correspond to like-numbered elements in the figures. FIGS. 1 and 2 disclose four interconnected can holders 20a, 20b, 20c, 20d in accordance with the present invention, with each can holder 20 including a cavity 22 for receiving a can or bottle 23 or the like. Each can holder 20 includes opposed side portions 24 and 26, with the side portions 24, 26 comprising connecting members whereby the side portion 24 of one can holder is connectable to the side portion 26 of another can holder 20 such that the can holders 20 may be interconnected in an adjacent relationship such as shown in FIGS. 1 and 2. In the illustrated embodiment each can holder 20 additionally includes mounting members comprising a plurality of magnets 28 mounted on the back portion of the can holder such that a single can holder 20, or multiple interconnected can holders 20 as shown in FIGS. 1 and 2, may be mounted to a generally vertical metallic surface 32, such as a tool box, cabinet, appliance, machinery or the like.

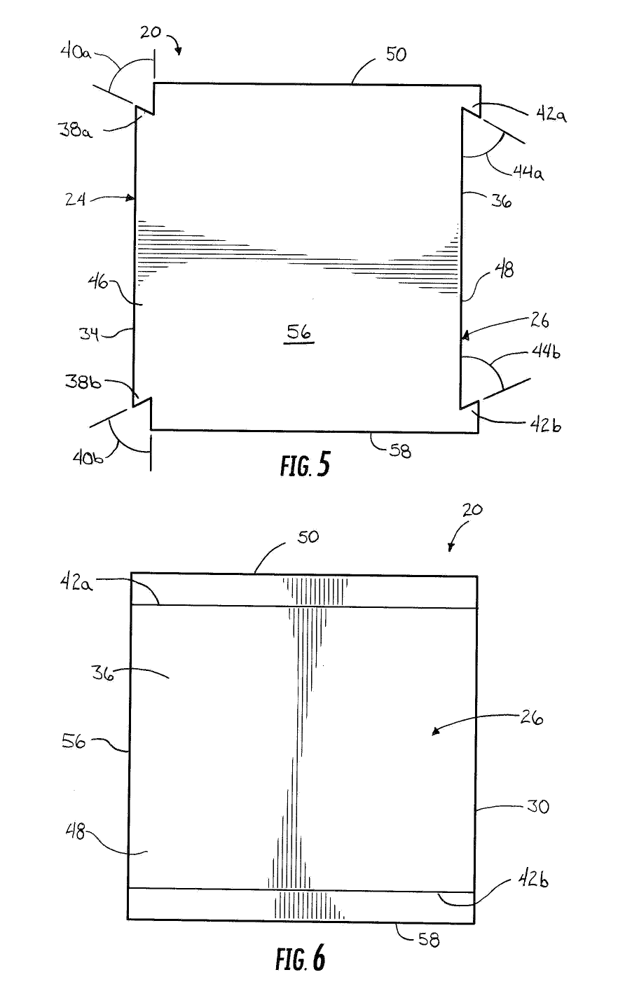

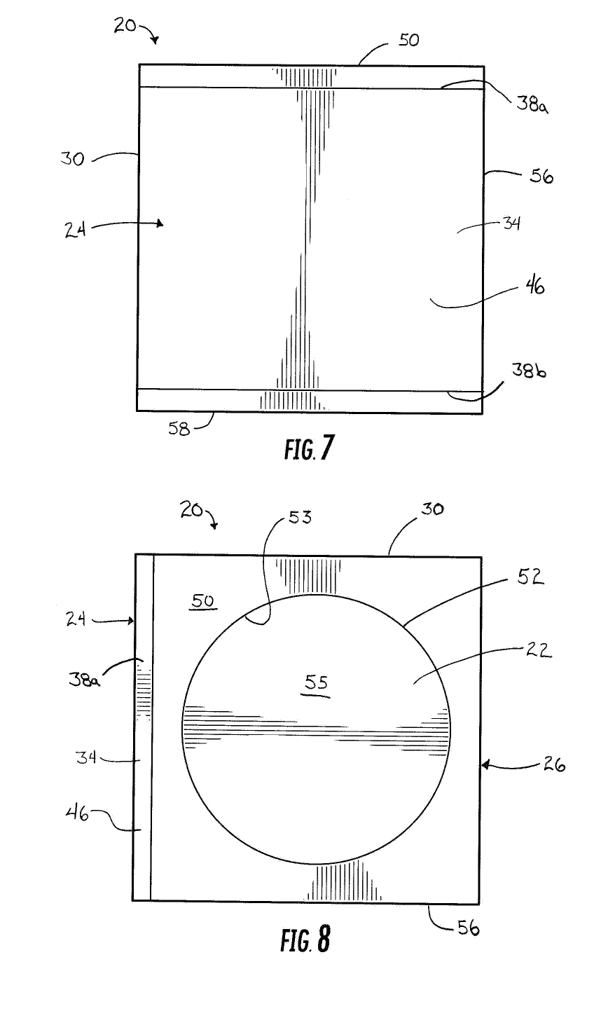

With additional reference to FIGS. 3-10 of the illustrated embodiment, side portion 24 of can holder 20 includes a protrusion member or extension member 34 and side portion 26 includes a socket 36, with extension member 34 of one can holder 20 being connectable to the socket 36 of another can holder 20 when multiple can holders 20 are interconnected. Can holders 20 are interconnectable via sliding engagement where extension member 34 includes a pair of angled slide rail members 38 comprising one upper slide rail member 38a and one lower slide rail member 38b, with the slide rail members 38a, 38b being generally bilaterally symmetrical or the mirror image of one another whereby the outwardly opening angle 40a (FIG. 5) of slide rail member 38a is oppositely directed relative to the outwardly opening angle 40b (FIG. 5) of slide rail member 38b. Correspondingly, socket 36 includes a pair of corresponding angled slide rail receivers 42 that are generally bilaterally symmetrical or the mirror image of one another, with the angle 44a (FIG. 5) of slide rail receiver 42a and the angle 44b (FIG. 5) of slide rail receiver 42b generally opening toward each other. Accordingly, the slide rail members 38 of one can holder 20 are configured for engaging the slide rail receivers 42 of an adjacent can holder 20. As shown in the illustrated embodiment, slide rail members 38a, 38b and slide rail receivers 42a, 42b form dovetail joint connectors for securing with adjacent, like configured can holders 20 where extension members 34 comprise a dovetail joint tail portion 46 and sockets 36 comprise a dovetail joint receptacle portion 48.

Thus, one can holder 20 may be connected to another can holder 20 in adjacent relationship by sliding engagement of the two can holders together, with the can holders 20 being slid in a direction that is generally perpendicular relative to the longitudinal axial orientation of cavity 22. Sliding engagement of can holders 20 in this direction enables can holders 20 to be joined to a can holder 20 that is already mounted to a generally vertical surface 32 without the holder 20 that is to be attached having to slide against the vertical surface 32. In the illustrated embodiment, side portion 24 comprises slide rail members 38 and side portion 26 comprises slide rail receivers 42 which form dovetail joints with adjacent like configured can holders 20. It should be appreciated, however, that alternative sliding connections other than dovetail joints may be employed within the scope of the present invention. For example, alternatively configured extension members or rail members and sockets or rail receivers may be employed, such as a single rail member on a side and a single rail receiver on a side and/or arrangements utilizing T-shaped or barbell shaped extension members and sockets.

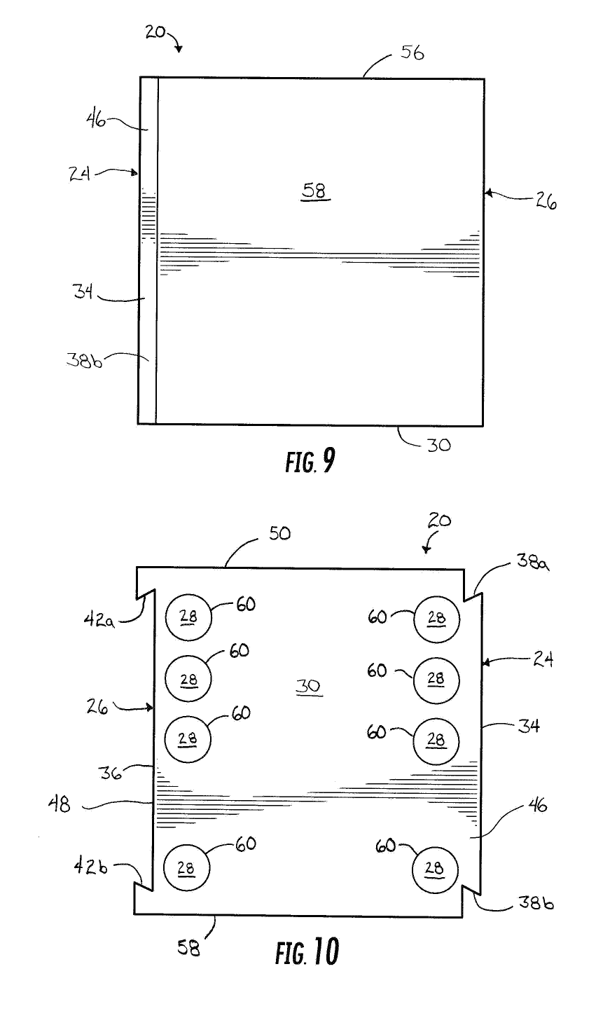

The can holders 20 of the illustrated embodiment are generally cubical and constructed from plastic or polymeric materials, with side portion 24 and side portion 26 forming distally opposed sides that are generally planar and generally parallel to one another. Can holders 20 further include a top portion or top surface 50, with cavity 22 forming a cavity opening 52 in top surface 50 and having a cavity sidewall 53 and cavity bottom 55 (FIG. 8). Each can holder 20 further includes a front surface or portion 56 and a bottom surface or portion 58, with side portion 24, side portion 26, top surface 50, back portion 30, front surface 56 and bottom surface 58 each being generally orthogonal relative to their adjacent portions or surfaces.

As noted, back portion or surface 30 may include multiple magnets 28. In the illustrated embodiment, back portion 30 includes eight magnets 28 that comprise conventional ND0421-42NM magnets supplied by CMS Magnetics Inc. of Plano, Tex. Magnets 28 are disk shaped and mounted within cavities 60 formed on back portion 30, such as by gluing magnets 28 within cavities 60 whereby the exposed surface of the magnets 28 is approximately flush with back surface 30. As an alternative, a can holder may be constructed in which the mounting member or members comprise one or more holes, hooks, hook and loop fasteners, or loops, or the like, on a back portion for mounting to a comparable joining member (not shown) on a vertical surface. Still further, a can holder may be constructed without magnets or other such mounting elements.

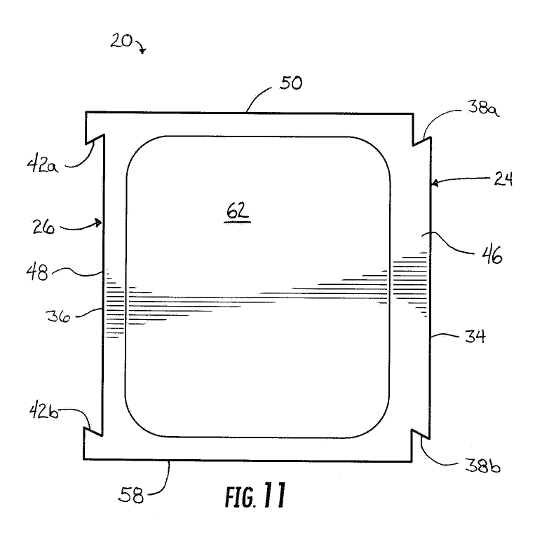

With reference to FIG. 11, a cover member 62 may be affixed to back portion 30 to cover magnets 28. Cover member 62 may be constructed of a rubber or cloth like material, or a thin plastic material, and be used to prevent marring of a vertical surface 32 to which can holder 20 is affixed and/or to aid in the ease of removal of can holder 20 from such a vertical surface 32. Cover member 62 is generally thin so as not to excessively reduce the holding force of magnets 28 to such a vertical surface 32.

A single can holder 20 may be used by itself or two or more can holders 20 may be used together, including more than four as illustrated in FIGS. 1 and 2. Moreover, alternative can holders may also be constructed for interconnecting without the use of a sliding connection in which a protrusion member or extension member of one such alternative can holder may be received within the socket of another like configured can holder for selectively connecting the alternative can holders together and/or with additional like configured alternative can holders. Such an alternative connection may, for example, employ a snap fit or plug type connection. In addition, although the illustrated dovetail joint connections disclose interconnection via sliding engagement in a direction that is generally perpendicular relative to the longitudinal axial orientation of cavity, alternative can holders may be configured in which a sliding engagement connection, such as by dovetail joints or otherwise, may be accomplished via sliding engagement in a direction that is generally parallel to the longitudinal axial orientation of cavity. Still further, although can holders 20 are disclosed with side portion 24 and side portion 26 forming opposed sides of can holders 20 such that can holders 20 form a linear row of can holders 20 when interconnected, it should be appreciated that connecting members may be placed on alternative sides, such as adjacent sides. In the illustrated embodiment, cavity 22 is disclosed as being generally cylindrical. Alternative shapes may alternatively be employed, such as rectangular or conical.

The can holder of the present invention provides a convenient storage retainer for cans and bottles that may be employed without taking up horizontal surfaces. The connecting members of the side portions enable two or more can holders to be organized together in interconnected formation. Magnets installed to the back portion of the can holders enable the can holders to be mounted to generally vertical metallic surfaces, such as work benches or tool boxes. Accordingly, the can holders provide convenient and organized storage for cans and bottles, and even for parts and/or components that might be stored within the holders.

Changes and modifications in the specifically described embodiments can be carried out without departing from the principles of the present invention which is intended to be limited only by the scope of the appended claims, as interpreted according to the principles of patent law including the doctrine of equivalents.

1. A can holder, said can holder being connectable to like configured can holders and comprising:
an upper face and a cavity, said cavity defining a cavity opening on said upper face with said cavity being used to selectively receive objects;
a back portion, said back portion being generally orthogonal to said upper face and including a mounting element whereby said can holder is mountable to a generally vertical surface; and
two side portions that are distally opposed relative to each other, one of said side portions being generally orthogonal to said back portion and said upper face and including an integral extension member and the other of said side portions including an integral socket and being generally orthogonal to said portion and said upper face;
said can holder being a single unitary piece construction and connectable to additional can holders with said extension member of said can holder being selectively connectable to a socket of a second can holder and said socket of said can holder selectively receiving an extension member of a third can holder, wherein said extension member comprises a slide rail member and said socket comprises a slide rail receiver, and wherein said slide rail member and said slide rail receiver are oriented for sliding engagement with additional can holders in a generally perpendicular direction relative to the longitudinal orientation of said cavity.

2. (canceled)

3. The can holder of claim 1, wherein said extension member comprises two slide rail members and said socket comprises two slide rail receivers.

4. The can holder of claim 3, wherein said can holder is connectable to additional can holders via dovetail joints at said side portions, with said extension member comprises a single dovetail joint tail portion defined by said two slide rail members and said socket comprises a single dovetail joint receptacle portion defined by said two slide rail receivers.

5.-6. (canceled)

7. The can holder of claim 4, wherein said mounting element comprises a magnet, said magnet enabling said can holder to be mounted to a generally vertical metallic surface.

8. The can holder of claim 7, further comprising a cover member on said back portion, said cover portion covering said magnet.

9. The can holder of claim 1, wherein said can holder is generally cubical, with said side portions being disposed on opposed sides such that said side portions are generally planar and parallel with respect to one another and such that said side portions are generally perpendicular relative to said upper face.

10. The can holder of claim 1, wherein said cavity is substantially cylindrical.

11. Interconnectable can holders comprising:
a plurality of can holders, each said can holder comprising;
an upper face and a cavity, said cavity defining a cavity opening on said upper face with said cavity being used to selectively receive objects; and
two side portions, one of said side portions including an extension member and the other of said side portions including a socket, wherein each said can holder is generally cubical, with said side portions being disposed on opposed sides such that said side portions are generally planar and parallel with respect to one another and such that said side portions are generally perpendicular relative to said upper face;
said extension member of each said can holder being selectively connectable to said socket of another said can holder, and with said socket of each said can holder being selectively connectable to said extension member of another said can holder to adjacently interconnect said can holders, wherein said extension member of each said can holder comprises a slide rail member and said socket of each said can holder comprises a slide rail receiver, with said slide rail member being oriented for sliding engagement with said slide rail receiver of another said can holder in a generally perpendicular direction relative to the longitudinal orientation of said cavity, and with said slide rail receiver being oriented for sliding engagement with said slide rail member in a generally perpendicular direction relative to the longitudinal orientation of said cavity.

12. (canceled)

13. The can holders of claim 11, wherein each said can holder is a single unitary piece construction with said extension member of each said can holder comprises an integral slide rail member and said socket of each said can holder comprises an integral slide rail receiver.

14. The can holder of claim 13, wherein said extension member of each said can holder comprises two slide rail members and said socket of each said can holder comprises two slide rail receivers.

15. The can holders of claim 14, wherein said can holders are connectable to additional can holders via dovetail joints at said side portions, with said extension member of each said can holder comprising a dovetail joint tail portion and said socket of each said can holder comprising a dovetail joint receptacle portion.

16. The can holders of claim 11, wherein each said can holder further comprises a back portion, said back portion including a magnet enabling said can holders to be mounted to a generally vertical metallic surface.

17. A can holder, said can holder being connectable to like configured can holders and comprising:
an upper face and a cavity, said cavity defining a cavity opening on said upper face with said cavity being used to selectively receive objects;
two side portions, one of said side portions including an extension member and the other of said side portions including a socket; and
a back portion, said back portion including a cavity and a magnet mounted within said cavity whereby an exposed surface of said magnet is approximately flush with a back surface of said back portion, said magnet enabling said can holder to be mounted to a generally vertical metallic surface;
said can holder being generally cubical, with said side portions being disposed on opposed sides such that said side portions are generally planar and parallel with respect to one another and such that said side portions are generally perpendicular relative to said upper face, and with said back portion being generally perpendicular to said side portions and said upper face;
said can holder being connectable to additional can holders via dovetail joints at said side portions with said extension member comprising a single dovetail joint tail portion and said socket comprising a single dovetail joint receptacle portion with said tail portion of said can holder being selectively connectable to a receptacle portion of a second can holder by sliding in a generally perpendicular direction relative to the longitudinal orientation of said cavity and said receptacle portion of said can holder selectively receiving a tail portion of a third can holder by sliding in a generally perpendicular direction relative to the longitudinal orientation of said cavity.

18. The can holder of claim 18, wherein said back portion includes a plurality of cavities and a plurality of magnets, and wherein said magnets are mounted within said cavities whereby an exposed surface of said magnets is approximately flush with a back surface of said back portion.
